(19) United States
(12) Patent Application Publication
(10) Pub. No.: US 2024/0392054 A1
(43) Pub. Date: Nov. 28, 2024

(54) IMPROVED MONOMER COMPOSITIONS FOR TEMPERATURE RESISTANCE AFTER CURING

(71) Applicant: ILLUMING POWER INC., Vancouver (CA)

(72) Inventors: Daniel RAMRUS, Vancouver (CA); Marek GNATOWSKI, Coquitlam (CA); Mathew Man Kit LEUNG, Burnaby (CA)

(21) Appl. No.: 18/696,150

(22) PCT Filed: Sep. 16, 2022
(86) PCT No.: PCT/US2022/043899

§ 371 Date: Mar. 27, 2024

Related U.S. Application Data
(60) Provisional application No. 63/249,687, filed on Sep. 29, 2021.

(51) Int. Cl. C08F 220/18; C08F 222/10; C08F 222/20; C09D 133/08; C09D 135/02; H01M 8/0234; H01M 8/0239; H01M 8/0241

(52) U.S. Cl. CPC C08F 220/1811; C08F 222/103; C08F 222/20; C09D 133/08; C09D 135/02; H01M 8/0234; H01M 8/0239; H01M 8/0241

(57) ABSTRACT

Certain monomer composition mixtures having desirable properties for purposes of impregnating porous substrates (e.g. low viscosity, low vapor pressure, low viscosity) have also been found after curing to have surprisingly good mechanical characteristics at elevated temperature (e.g. relatively high storage modulus and flexural stress at ≥90° C.). These monomer compositions comprise a blend of at least two different monomers, the first being a mono- or difunctional methacrylic or acrylic ester and the second being a polyfunctional methacrylic or acrylic ester. The total amount of monofunctional and difunctional monomers in the composition is in a weight range from about 20 to about 90% and the total amount of polyfunctional monomers is in a weight range from about 10 to about 80%. These monomer compositions are particularly suitable for preparing robust, impregnated carbon plates for use in solid polymer electrolyte fuel cells, which typically operate around this elevated temperature.

### TECHNICAL FIELD

This invention pertains to a monomer composition for impregnating porous substrates that have desirable properties for impregnation purposes while still providing impregnated parts with unexpectedly superior mechanical properties at elevated temperature. In particular, it pertains to certain methacrylic and/or acrylic ester monomers for use in preparing impregnated porous carbon plates for use in solid polymer electrolyte fuel cells.

### BACKGROUND

There are numerous industrial applications involving porous parts that are desirably impregnated with monomer composition for sealing purposes and/or to improve mechanical, chemical, or other properties of the impregnated part. For instance, such applications include the impregnation of metal castings, powdered and sintered metal parts, electronic components and activated carbon for pollution mitigation. In general, impregnation involves filling the voids in the target solid porous part with monomer composition in a low viscosity, liquid state after which the monomer composition is solidified by a curing process. Settable (polymerizable) polymers are thus often useful as impregnating monomer composition as they can readily be obtained in an easily handled, liquid form but subsequently can be cured (copolymerized) into a robust set polymer. Vacuums and/or pressurizing steps are commonly employed to assist the impregnation process.

An increasingly common application for impregnated porous carbon parts is for use as the flow field plates (also known as separators) found in solid polymer electrolyte fuel cells. Such fuel cells electrochemically convert fuel (typically hydrogen) and oxidant (typically oxygen) to generate electric power and this process is carried on at elevated temperatures which requires fuel cell parts with high temperature resistance. They generally employ a proton conducting polymer membrane electrolyte between two electrodes, namely a cathode and an anode. The cathode and anode electrodes comprise appropriate catalysts to accelerate the desired reactions taking place in the fuel cell. Frequently, the cathodes and anodes are applied directly to the membrane electrolytes to form unitary assemblies known as catalyst coated membrane assemblies (CCMs). Gas diffusion layers (typically porous, electrically conductive layers comprising carbon fibers or the like) are provided adjacent the electrode surfaces of the CCM in order to improve the distribution of fluids to and from the electrodes during operation. Structures comprising a CCM sandwiched between two gas diffusion layers electrodes are known as a membrane electrode assembly (MEA). In a typical solid polymer electrolyte fuel cell, flow field plates comprising numerous fluid distribution channels for the reactants are provided on either side of a MEA to deliver fuel and oxidant firstly to the respective gas diffusion layers and then the electrodes in the cell and then to remove by-products of the electrochemical reactions taking place within the cell. Water is the primary by-product in a cell operating on hydrogen and air reactants and typically operating temperatures range from around 80 to 100° C. For this reason, materials used in fuel cell bipolar plates must maintain their structural properties at these elevated temperatures. Because the output voltage of a single cell is of order of IV, a plurality of cells is usually stacked together in series for commercial applications. Fuel cell stacks can be further connected in arrays of interconnected stacks in series and/or parallel for use in automotive applications and the like.

Along with water, heat is a significant by-product from the electrochemical reactions taking place within the fuel cell. Means for cooling a fuel cell stack is thus generally required. Stacks designed to achieve high power density (e.g. automotive stacks) typically circulate liquid coolant throughout the stack in order to remove heat quickly and efficiently. To accomplish this, coolant flow fields comprising numerous coolant channels are also typically incorporated in the flow field plates of the cells in the stacks. The coolant flow fields may be formed on the electrochemically inactive surfaces of the flow field plates and thus can distribute coolant evenly throughout the cells while keeping the coolant reliably separated from the reactants.

Bipolar plate assemblies comprising an anode flow field plate and a cathode flow field plate which have been bonded and appropriately sealed together so as to form a sealed coolant flow field between the plates are thus commonly employed in the art. Various transition channels, ports, ducts, and other features involving all three operating fluids (i.e. fuel, oxidant, and coolant) may also appear on the inactive side of these plates. The operating fluids may be provided under significant pressure and thus all the features in the plates must be sealed appropriately to prevent leaks between the fluids and to the external environment. The bipolar plates must be chemically resistant against these fluids at elevated temperatures. A further requirement for bipolar plate assemblies is that there is a satisfactory electrical connection between the two plates. This is because the substantial current generated by the fuel cell stack must pass between the two plates.

Numerous variants of flow field plate designs and materials of bipolar plate assemblies appear in the art. The plates and/or assemblies may optionally be metallic, in which case they are typically formed using a variety of stamping steps from a sheet or sheets of suitable specialty metals. These are subsequently welded or adhesively bonded and sealed together so as to appropriately seal all the fluid passages from each other and from the external environment.

Flow field plates and bipolar plate assemblies may also optionally be made of carbon. Carbon can be a preferred material for such applications because of its desirably high corrosion resistance, good electrical conductivity, relative ease of manufacture and relative low cost. Flexible graphite or expanded graphite sheets and the like are commonly used as substrates for manufacturing flow field plates for fuel cells. These carbon sheets are readily handled, and complex structures can easily be embossed therein. They are however porous and must be impregnated with a suitable filler or monomer composition to suitably seal the plates and prevent liquids or gases from leaking through. Further, the cured, impregnated monomer composition is also required to impart additional other desirable mechanical properties to the product flow field plates, including stiffness over a range of fuel cell operating temperatures. A high glass transition temperature, Tg, is thus considered desirable.

Finding a suitable monomer composition that meets all the requirements for fuel cell applications can be challenging. Aside from having desirable mechanical properties, and like the underlying porous substrate itself, a suitable monomer composition must also exhibit superior corrosion resistance to the fuel cell environment after curing. Further, a low electrical resistance is desirable as substantial current must flow efficiently through the flow field plates. Further still, for manufacturing purposes, a low viscosity is needed, regardless of shear stress present, for preferred methods for application. Also, subsequent curing should be fast. At present, typical commercial monomer composition for such fuel cell applications comprise an acrylate or mixtures of acrylates (e.g. a mixture of isobornyl methacrylate and polyglycol dimethacrylate)

Notwithstanding those commercial monomer composition exist for impregnating and producing adequate flexible porous carbon based flow field plates for use in fuel cells, there remains a need for monomer composition that can provide still better properties, and particularly mechanical properties.

This invention fulfills these needs and provides further related advantages as disclosed below.

### SUMMARY

Improved monomer composition formulations have been discovered that have desirable properties for commercial impregnating of various porous substrates while unexpectedly having superior mechanical properties after curing, and particularly at high temperatures (e.g. about 90° C.). For instance, the mechanical properties of the compositions can exceed those of its individual components.

These monomer composition formulations comprise a blend of at least two different types of methacrylic or acrylic ester monomers, namely a first such monomer that is mono- or difunctional and a second such monomer that is polyfunctional. The viscosity of such monomer composition blends desirably can be less than 30 cP (typically needed for practical impregnation of porous materials) and yet wherein the storage modulus as measured by DMA of the monomer composition after curing can be greater than about 1000 MPa at 100° C.

Specifically, the monomer composition comprises a first monomer selected from the group consisting of methacrylic esters and acrylic esters in which the first monomer is either monofunctional or difunctional and a second polyfunctional monomer selected from the group consisting of methacrylic esters and acrylic esters. The total amount of monofunctional and difunctional monomers in the composition, namely the amount of the first monomer plus any other monofunctional and difunctional monomers in the composition, is in a range from about 20 to about 90% by weight. The total amount of polyfunctional monomers in the composition, namely the amount of the second monomer plus any other polyfunctional monomers in the composition, is in a range from about 10% to about 80% by weight. Both the first and second monomers have a vapor pressure below 0.15 mm Hg (@ 25° C., and viscosities under 50 and 200 cP at 25° C. respectively allowing rapid vacuum impregnation.

In exemplary embodiments, the first monomer is a monofunctional monomer selected from the group consisting of hydroxyethyl methacrylate, isobornyl acrylate, isobornyl methacrylate, adamantyl acrylate, and adamantyl methacrylate. Alternatively the first monomer is a difunctional monomer selected from the group consisting of dipropylene glycol diacrylate, methacrylate ester, phenyl methacrylate, cyclohexyl methacrylate, benzyl methacrylate, dihydrodicyclopentadienyl acrylate, 3-Hydroxy-2,2-dimethylpropyl 3-hydroxy-2,2-dimethylpropionate diacrylate, dipropylene glycol diacrylate, dipropylene glycol dimethacrylate, neopentyl glycol diacrylate and dimethylol tricyclodecane diacrylate.

In exemplary embodiments, the second monomer is a polyfunctional monomer selected from the group consisting of trimethylolpropane trimethacrylate, trimethyllolpropane triacrylate, pentaerythritol (ethylene oxide)n tetraacrylate, trimethylolpropane propoxylate triacrylate, and trimethylolpropane triacrylate.

Monomer composition of the invention can comprise additional suitable methacrylic ester or acrylic ester monomers, for instance a third monomer selected from the group consisting of methacrylic esters and acrylic esters in which the third monomer is a monofunctional or difunctional monomer. In a like manner to the other components, the third monomer can also have a vapor pressure below 0.15 mm Hg a 25° C. and a viscosity under 200 cP at 25° C.

As demonstrated in the Examples below, desirable results can be obtained for instance from monomer compositions comprising isobornyl methacrylate, dipropylene glycol diacrylate, and trimethylolpropane trimethacrylate, for instance in a weight ratio of about 20:40:40 20:60:20, 0:20:80, 0:80:20, 25:0:75, or 80:0:20. Desirable results can also be obtained from monomer compositions comprising isobornyl methacrylate, dipropylene glycol diacrylate, and trimethylolpropane triacrylate, for instance in a weight ratio of about 20:70:10, 20:60:20, 20:50:30, or 20:40:40. Further, desirable results can also be obtained from monomer compositions comprising isobornyl methacrylate, dipropylene glycol diacrylate, and pentaerythritol (ethylene oxide)n tetraacrylate, for instance in a weight ratio of about 20:60:20.

The invention also includes methods of making a cured, impregnated substrate based on use of the aforementioned monomer composition. Generally, the methods comprise: obtaining a porous substrate, preparing an impregnation mixture comprising an amount of the inventive monomer composition, impregnating the porous substrate with the impregnation mixture, and then curing the impregnated monomer composition in the porous substrate.

Suitable porous substrates include carbon substrates, for instance one selected from the group consisting of graphite, expanded graphite, porous carbon foam, porous carbon, conductive carbon, and carbon. A specific application involves making a cured, impregnated substrate for use as a separator plate for a fuel cell. A particularly suitable porous substrate for this purpose is expanded graphite. And a particularly suitable fuel cell is a solid polymer electrolyte fuel cell which typically operates at about 90° C. The invention however includes any product comprising a cured, impregnated substrate based on use of the aforementioned monomer composition and/or methods.

In one embodiment, the curing step can be performed without the use of an initiator simply by exposing the impregnated copolymer composition in the porous substrate to electron beam energy. In other embodiments, a suitable initiator may be employed to accelerate and ease curing. In such a case, the method additionally comprises obtaining a free radical polymerization initiator, and preparing the impregnation mixture comprising the amount of the monomer composition with an amount of the initiator.

In certain instances when an initiator is employed, it can be desirable to use more than one initiator. That is, the total amount of initiator employed may comprise an amount of a first initiator and an amount of a second initiator. The amount of the first initiator may initially be added to the amount of the monomer composition and mixed. Then the amount of the second initiator may be added to this mixture of the first initiator and the monomer composition and thereafter the amount of the second initiator and the mixture of the first initiator and the monomer composition may be mixed, thereby preparing the completed impregnation mixture. In exemplary embodiments in the following Examples, the first and second initiators are chosen so as to activate at different temperatures to provide for improved properties in the cured impregnated substrate.

Further, to thoroughly impregnate the substrates, the method can also include the additional steps of: subjecting the porous substrate to a vacuum before the impregnating step and/or after the impregnating step, and thereafter subjecting the impregnated porous substrate to air at above ambient pressure atmosphere.

The curing step in the methods can be relatively quick. In exemplary embodiments for instance, the curing step can comprise a first heating for about 30 minutes between 70-95° C., followed by a second heating for about 30 minutes at 160-200° C.

These and other aspects of the invention are evident upon reference to the following detailed description.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

Further, the following definitions have been used herein. In a quantitative context, the term “about” should be construed as being in the range up to plus 10% and down to minus 10%.

Herein, “acrylate” refers a salt or an ester of acrylic acid. During polymerization, an acrylate can form a chain with another acrylate or methacrylate. It also contains an R group (or multiple R groups) which is an atom or a group of atoms that does not take part in the reaction.

Methacrylate refers to a salt or ester of methacrylic acid. During polymerization, a methacrylate can form a chain with another acrylate or methacrylate. It also contains an R group (or multiple R groups) which is an atom or a group of atoms that does not take part in the reaction.

“Diacrylates” or “dimethacrylates” have two available groups for bonding and therefore can form linear chains and crosslinks between similar chemicals. It also contains an R group which is an atom or a group of atoms that does not take part in the reaction.

“Polyacrylates” or “polymethacrylates” refer to the ability of the chemical to crosslink at three or more locations allowing for a higher degree of crosslinking. It also contains an R group (or multiple R groups) which is an atom or a group of atoms.

A “monomer” has the plain meaning as used in the art, namely it is a molecule that can be bonded to other identical molecules to form a polymer.

A “reactive group” refers to molecules of an organic compound undergoing change in a chemical reaction.

A “monofunctional” monomer is a monomer with one reactive group on either end that allows for a linear chain of molecules to be formed via polymerization.

A “difunctional” monomer is a monomer with two reactive groups that allow for branched chains of molecules to be formed in addition to linear chains and to increased crosslinking via polymerization

A “polyfunctional” monomer is a monomer that has three or more reactive groups on each end that allow for greater branched chains of molecules to be formed and a high degree of crosslinking with improved physical and chemical stability via polymerization.

It has been discovered that a monomer composition comprising certain blends of methacrylic esters and/or acrylic esters can have desirable properties for impregnating porous substrates while providing surprisingly improved mechanical characteristics after curing, particularly at elevated temperature. The mechanical properties such as storage modulus and/or flexural stress of the cured monomer compositions for instance can be surprisingly better than that of the individual components used in the blends. In some instances, the flexural stress at break of some of these cured monomer compositions could be improved in spite of having relatively lower glass transition temperatures. The storage modulus as measured by DMA can also be significantly increased beyond the simple weighted average of the raw components.

Monomer composition of the invention comprise a blend of at least two different monomers selected from the group consisting of methacrylic esters and acrylic esters, namely a first and a second monomer. The first monomer is a monofunctional or difunctional monomer, while the second monomer is a polyfunctional monomer. Both first and second monomers are selected so as to have a vapor pressure below 0.15 mm Hg (25° C. and a viscosity under 50 cP at 25° C. and hence have desirable properties for impregnating porous substrates at ambient temperatures. Desirably they can also have a surface tension under 50 dyne at 25° C., In addition, if the first monomer is the sole monofunctional and difunctional monomer in the composition, the monomer composition comprises from about 20 to about 90% by weight of the first monomer. If additional monofunctional and/or difunctional monomers are employed in the composition, the total amount of monofunctional and difunctional monomers in the composition (i.e. the amount of the first monomer plus the amounts of these other monofunctional and/or difunctional monomers) is in a range from about 20 to about 90% by weight. In a like manner, if the second monomer is the sole polyfunctional monomer in the composition, the monomer composition comprises from about 10 to about 80% by weight of the second monomer. If additional polyfunctional monomers are employed in the composition, the total amount of polyfunctional monomers in the composition (i.e. the amount of the second monomer plus the amounts of these other polyfunctional monomers) is in a range from about 10 to about 80% by weight. These polyfunctional monomers typically have a higher viscosity which results in lower impregnation rates and which in turn further reduces the strength of the final composite.

Suitable choices for the first monomer are monofunctional monomers including, but not limited to, hydroxyethyl methacrylate (registry number or RN=868-77-9), isobornyl acrylate (RN=5888-33-5), isobornyl methacrylate (RN=7534-94-3), adamantyl acrylate (RN=128756-71-8), and adamantyl methacrylate (RN=16887-36-8).

Suitable choices for the first monomer are difunctional monomers including, but not limited to, dipropylene glycol diacrylate (RN=85996-31-2), methacrylate ester (RN=80-62-6), phenyl methacrylate (RN=2177-70-0), cyclohexyl methacrylate (RN=101-43-9), benzyl methacrylate (RN=2495-37-6), dihydrodicyclopentadienyl acrylate (RN=12542-30-2), 3-hydroxy-2,2-dimethylpropyl 3-hydroxy-2,2-dimethylpropionate diacrylate (RN=30145-51-8), dipropylene glycol diacrylate (RN=57472-68-1), dipropylene glycol dimethacrylate (RN=1322-73-2), neopentyl glycol diacrylate (RN=2223-82-7), and dimethylol tricyclodecane diacrylate (RN=42594-17-2).

Suitable choices for the second polyfunctional monomer in the monomer composition of the invention include, but are not limited to, trimethylolpropane trimethacrylate (RN=3290-92-4), pentaerythritol (ethylene oxide)n tetraacrylate (RN=51728-26-8), trimethylolpropane propoxylate triacrylate (RN=53879-54-2), and trimethylolpropane triacrylate (RN=72269-91-1).

To adjust or improve certain properties of the monomer composition, additional components may also be incorporated into the monomer composition blends. For instance, an additional related monomer or monomers may be incorporated, e.g. a third monomer similar to the first monomer (i.e. either a methacrylic ester or an acrylic ester that is also a monofunctional or difunctional monomer and preferably having a vapor pressure below 0.15 mm Hg (a, 25° C. and a viscosity under 50 cP at 25° C.) may be incorporated as well. Such a third monomer may be incorporated in amounts such that the total amount of monofunctional or difunctional monomers in the composition range is from about 20 to about 90% by weight. Yet further additional and/or optional components may be included in the monomer composition such as wetting agents, surfactants, defoamers, adhesion promoters, stabilizers, antiplasticizers, and other additives known to the industry.

Further still, while satisfactory curing may be obtained (e.g. via exposure to electron beam energy) without the use of additional components (e.g. initiators), in order to cure the monomer composition in a timely manner after impregnating a desired substrate, at some point, suitable initiators may be incorporated in the monomer composition to initiate polymerization (curing) of the monomer composition. Suitable initiators include a variety of free radical polymerization initiators that use a free radical polymerization or a peroxide type of catalyst. While polymerization initiated by such initiators/catalysts is frequently accelerated by the application of some external trigger (e.g. heat, moisture, electron beam or e-beam, etc.) in order to proceed at reasonable rates for manufacturing purposes, lower rates of polymerization can still be expected during storage under ambient conditions.

It can therefore be preferred to prepare, ship, and store the monomer composition blends without initiators present to minimize premature curing of the monomer composition (with initiators added later prior to use). For similar reasons, it may also be desirable to include suitable stabilizers in the monomer composition.

As mentioned above, the monomer composition may comprise from about 20 to about 90% by weight of the first ester monomer (including any other similar mono- or di-functional monomers if present, such as an optional third ester monomer) and from about 10 to about 80% by weight of the second ester monomer (including any other similar polyfunctional monomers if present). As illustrated in the following Examples, improved properties may be expected for cured, impregnated monomer composition over these ranges. For instance, monomer compositions comprising isobornyl methacrylate, dipropylene glycol diacrylate, and trimethylolpropane trimethacrylate in a weight ratio of about 20:40:40 20:60:20, 0:20:80, 0:80:20, 25:0:75, or 80:0:20 can exhibit improved properties after curing. In addition, monomer compositions comprising isobornyl methacrylate, dipropylene glycol diacrylate, and trimethylolpropane triacrylate in a weight ratio of about 20:70:10, 20:60:20, 20:50:30, or 20:40:40 can also exhibit improved properties after curing. Yet further, monomer compositions comprising isobornyl methacrylate, dipropylene glycol diacrylate, and pentaerythritol (ethylene oxide)n tetraacrylate in a weight ratio of about 20:60:20 can also exhibit improved properties after curing. And also as mentioned, monomer composition blends such as these have desirable properties for impregnation purposes at ambient temperatures, e.g. having viscosities less than 30 cP. The vapour pressure also needs to be low enough not to volatilize during a vacuum-impregnation cycle (if used).

The general method for making a cured, impregnated substrate in accordance with the invention first involves obtaining the porous substrate to be desirably impregnated, and a suitable monomer composition of the invention. An impregnation mixture is then prepared comprising an amount of the inventive monomer composition. The impregnation mixture is then impregnated into the porous substrate. Finally, the impregnated monomer composition in the porous substrate is cured (e.g. with heat, anaerobic/IR or with e-beam). Optionally, a suitable free radical polymerization initiator may be employed to initiate and/or accelerate curing. In such a case, an impregnation mixture is typically prepared comprising an amount of the inventive monomer composition and an amount of the initiator. As before, the impregnation mixture is then impregnated into the porous substrate and the impregnated monomer composition in the porous substrate is suitably cured.

The present invention is potentially useful in preparing a variety of impregnated substrate products. In particular, it is useful for impregnating porous carbon substrates such as porous graphites (e.g. expanded or flexible graphites), carbon foams, or other porous carbons including castings and the like.

A variety of optional initiators may be considered for use in the methods depending on the monomer composition employed. Typical initiators are well known to those skilled in the art. Further, more than one initiator may be considered for use. For instance, as exemplified in the Examples below, impregnation mixtures may be prepared using an amount of a first initiator and an amount of a second initiator in which the initiators work together to allow for initial strength and increased crosslink density by grafting reaction and that binds as many of the monomers as possible into the polymer network. Unbound polymers result in an undesirable smell, and contamination risks to the fuel cell and other parts of the system. If more than one initiator is employed, these can be incorporated into the monomer composition mixture in a single step or multiple steps (e.g. by adding and mixing the amount of the first initiator into the amount of the monomer composition in a first step to form a mixture, followed by adding and mixing the amount of the second initiator into the mixture in a second step) thereby preparing the impregnation mixture. For instance, the first and second initiators may be chosen so as to activate at different temperatures. And the second initiator may for example be added once cool temperature storage conditions are available.

To thoroughly impregnate the porous substrate parts, appropriate vacuum and/or pressurization steps may be used. For instance, the porous substrate may be subjected to a vacuum before the impregnating step and/or after the impregnating step (e.g. at 0.01 bara pressure). Further, the impregnated porous substrate may be subjected to air or other appropriate gases at above ambient pressures (7 bara) after impregnation or after subjecting the impregnated porous substrate to a vacuum.

Again, depending on the monomer composition employed, a variety of curing methods may also be considered. As known by those skilled in the art, possible curing methods can include moisture, anaerobic, e-beam (electron beam), and/or thermal curing methods. As mentioned above, the use of an initiator is not required if e-beam curing methods are employed. However, an initiator or system of initiators may optionally be employed to achieve additional crosslinking even when using e-beam curing methods. Exemplary thermal methods can involve one or more heating steps. For instance, a complete curing step may comprise a first heating for about 2-30 minutes between 70-95° C. followed by a second heating for about 30 minutes at 160-200° C.

Monomer compositions of the invention offer a variety of advantages for impregnating porous substrates or parts generally. Their characteristics prior to curing allow for easy and simple handling and impregnating operations. And after curing, they have been demonstrated to have superior mechanical properties and particularly at higher temperatures. Desirably for instance the storage modulus of the cured pure monomer composition can be greater than about 1000 MPa as determined by DMA at 100° C. (samples that showed a storage modulus over 1000 MPa whereas an average of certain components would lead to an average around 600 MPa). Further still, the flexural stress of the cured monomer composition can desirably be greater than about 15 MPa at 90° C. Yet further. Tg values of 140° C. or greater (as measured from the maximum of tan delta curve generated by a DMA instrument) may be obtained. The advantage of an elevated Tg is an increase in mechanical properties at elevated temperatures. This can also be obtained by formulating a resin with high stiffness (as exemplified by the composition sample comprising IBOMA:TMPTMA with a weight ratio of 25:75 in the following Examples). As such, the monomer compositions of the invention are particularly desirable for use in preparing robust, impregnated carbon plates from porous expanded graphite substrates for use in solid polymer electrolyte fuel cells.

Without being bound by theory, it is believed that the combination of first and second monomers in the inventive monomer composition serve to form combinations of linear and/or branched chains that give the overall cured monomer composition improved mechanical properties without suffering from the steric hindrance that occurs with larger molecular weight monomers. The resulting polymer (cured monomer composition) has an appropriate number of crosslinks so as to result in superior mechanical properties at elevated temperatures and typically an elevated Tg. Another way of obtaining desirable performance at elevated temperature performance might be to increase the amount of crosslinking with additional quantities of polyfunctional monomers. But disadvantages of this approach include undesirably higher viscosity and raw material costs. In instances where improved flexural stress results are obtained without a correspondingly large associated improvement in Tg, it is believed this is due to the presence of polyfunctional groups in the monomer composition which can lead to improved mechanical properties but without a correspondingly improvement in Tg.

In the following Examples, samples of 100% IBOMA and 100% DPGDA were made but samples of 100% TMPTMA were not made due to challenges associated with getting cured monomer compositions from it without cracks or crazing. Further, the viscosity of trifunctional monomers such as TMPTMA and TMPTA is excessively high, making impregnation impractical due to the low amount of monomer that can be impregnated into porous substrates such as graphite.

Industrial acrylic and methacrylic monomers formulators and formulary literature generally accept that the glass transition temperature of the copolymer relates closely to Tg homopolymers made from the monomers which are its building blocks. The Tg of the random copolymer can be reasonably estimated by using the weight fraction of these monomers and their Tg values for the homopolymers. The rule assumes that the glass transition temperature of the copolymers can be divided into weighted additive contributions to the Tg that are independent of their neighbors. In other words, as we found copolymerizing two monomers, one monofunctional with Tg about 110° C. and second difunctional with Tg of 120° C. in a 50/50 weight ratio, one would expect a copolymer with intermediate Tg of about 115° C. and it was measured to be 119° C. However, when continuing experimental work, we discovered unexpectedly that the addition to these two monomers and a third monomer, which was trifunctional with Tg of its homopolymer of only 27° C., we obtained copolymer with Tg as high as 185° C. The weighted average of the Tg however was expected to be closer to 99° C. with a 20:60:20 ratio of IBOMA:DPGDA:TMPTMA. Further work, as presented below, showed that in fact adding to a certain mixture of single and difunctional acrylic esters other polyfunctional acrylic or methacrylic ester monomers with three or more functionality, similar effects are observed and Tg of copolymer can be increased significantly above the temperature which can be expected from the abovementioned rule. The investigation showed that a significant increase of Tg was seen for several formulations, where three and/or more functional monomers were added to monomers blend consisting of mono and difunctional acrylic esters and the obtained mixture was copolymerized. It was also found that monomers can be selected in such a way that the composition of monomers giving high temperature resistant copolymer made according to the invention may have properties required for impregnation of micro-porous materials under the vacuum e.g. low vapour pressure, low viscosity and low surface tension.

While the present disclosure is mainly directed at impregnation applications involving porous carbon substrates intended for use in fuel cells, the monomer composition and methods herein can also be expected to be desirable for use in many other applications, such as metal castings, electronics, and sintered metal applications.

The following examples are illustrative of the invention but should not be construed as limiting in any way.

### EXAMPLES

A series of monomer composition mixtures were prepared from a variety of ester monomers and these monomer composition mixtures were then used to produce cured, impregnated flexible graphite samples to determine suitability for use in solid polymer electrolyte fuel cells. The ester monomers used were:
commercial monomer composition comprising mainly isobornyl methacrylate and polyglycol dimethacrylate (as noted by the MSDS) herein denoted as “Hernon” obtained from Hernon under product name-HPS994R,
isobornyl methacrylate, herein denoted as IBOMA, obtained from Inortech under product name Genomer (1121M)
dipropylene glycol diacrylate, herein denoted as DPGDA, obtained from Sartomer under product name SR508, (Miramer M222)
trimethylolpropane trimethacrylate, herein denoted as TMPTMA, obtained from Sartomer under product name, (SR350)
trimethylolpropane triacrylate, herein denoted as TMPTA, obtained from Sartomer under product name, (SR351H) and
pentaerythritol (ethylene oxide)n tetraacrylate, herein denoted as PE (EO) TA, obtained from Miwon under product name Miramer 4004.

The properties reported below for the various monomer composition mixtures before and after curing were determined as follows. Vapour pressures, surface tensions, and densities of the starting ester monomers were those provided in the manufacturers' specifications. Viscosities of the uncured monomer composition mixtures were obtained before any initiators were incorporated using Ubbelohde capillaries and in accordance with ASTM standard testing method D445.

In all cases, the various monomer composition mixtures were cured using thermal methods, specifically by performing a first heating at 90° C. for 30 minutes, followed by a second heating at 180° C. also for 30 minutes. Representative tests were then performed on these cured monomer composition samples, including flexural stress, flexural modulus, storage modulus, and Tg. Some samples were also prepared in which certain monomer composition mixtures were impregnated into porous graphite substrates and cured. The porous graphite used was from Neograf with an area weight was 70 mg/cm² and a thickness of approximately 0.8 mm and of grade TG831. A vacuum-pressure impregnation method was used to assist impregnation of the monomer composition into the graphite, after which curing was carried out as above.

Flexural stresses and flexural modulus were obtained on both cured pure monomer composition samples and cured monomer composition impregnated samples using a Bluehill software controlled Instron Universal Testing Machine model 4400 equipped with an environmental chamber and 5 Kg load cell. The samples were tested in a 3 point bend test at 90° C. with a span of 38.5 mm following ASTM D-790. For pure monomer composition samples, a crosshead speed of 3.1 mm/min was used and the sample dimensions were approximately 14 mm wide with a thickness of 0.8 mm and a length of 50 mm with a span of 38.5 mm. For impregnated substrate samples, the crosshead speed was 4.36 mm/min and the sample dimensions were approximately 14 mm wide with a thickness of 0.55 mm and a length of about 50 mm with a span of 38.5 mm.

Glass transition temperature (Tg) and storage modulus measurements on slabs of cured monomer composition and on cured, impregnated porous graphites, as indicated, were conducted using a Netzsch Dynamic Mechanical Analyser model 242 following ASTM D-7028. A three point bend setup was used with nominal specimen geometries of 19 mm and a span of 10 mm. The thickness was about 0.55 mm for pure cured monomer composition and about 0.85 mm for cured impregnated graphite. The temperature ramp up was 25° C. to 200° C. at a rate of 10° C./min. The maximum dynamic force on a sample was 0.5 N at a frequency of 1 Hz, with a maximum amplitude of 30 μm, proportional factor of 1.2 and a static force of 0.001N.

Note that testing was performed at elevated temperatures because the properties are always lower than at elevated temperature and this reflects the upper operating temperature of fuel cells for automotive applications.

Properties of the ester monomers used in these Examples are summarized in Table 1 below.

TABLE 1
Physical properties of pure monomers or commercial
monomer composition (based on supplier datasheets)

| | Vapor | | Surface | | |
|---|---|---|---|---|---|
| | pressure | Viscosity | tension | Tg by | |
| | (mm Hg | (cP at | (dynes | DSC | Density |
| Monomer | at 25° C.) | 25° C.) | at 25° C.) | (° C.) | (g/cc) |
| IBOMA | 0.11 | 11 | 31.7 | 110 | 0.98 |
| DPGDA | 0.0006 | 10 | 33 | 104 | 1.052 |
| TMPTMA | 0.01 | 44 | 34 | 27 | 1.061 |
| TMPTA | 0.0006 | 106 | 36.1 | 62 | 1.109 |
| PE(EO)TA | 0 | 120-200 | 40.9 | 36 | 1.18 |
| Hernon | NA | 5-15 | 30.1 | NA | 1.01 |
| 994R* | | | | | |

Monomer composition mixtures were prepared using various combinations of these ester monomers in varying weight ratios. Two initiators with differing activation temperatures along with inhibitors were added to allow for extended storage and cure and the sample blends were mixed for a few minutes.

A listing of all the samples of pure monomer composition mixtures that were obtained or prepared and then cured, along with the properties that were measured appears in Table 2 below.

TABLE 2
Pure monomer composition samples evaluated and physical properties.

| | | | Flexural | | |
|---|---|---|---|---|---|
| | | Flexural | Modulus | | Storage |
| | | stress at | from 3 pt | | Modulus |
| | | break | bend | | (E′) from |
| | | @90° C. | (.5-1.25%) | Tg from | DMA at |
| | Ratios | 3 pt bend | @90° C. | DMA | 100° C. |
| Monomer composition sample | (weight %) | (MPa) | (MPa) | (° C.) | (MPa) |
| Hernon 994R | 100 | 4 | 147 | 109 | 546 |
| IBOMA | 100 | | | 103 | 885 |
| DPGDA | 100 | | | 120 | 563 |
| IBOMA:DPGDA | 80:20 | 6 | 556 | 126 | 1385 |
| IBOMA:DPGDA | 60:40 | | | 116 | 907 |
| IBOMA:DPGDA | 50:50 | 5 | 340 | 119 | 959 |
| IBOMA:DPGDA | 40:60 | | | 112 | 785 |
| IBOMA:DPGDA | 20:80 | 14 | 698 | 137 | 1137 |
| IBOMA:DPGDA:TMPTA | 20:70:10 | | | 118 | 1173 |
| IBOMA:DPGDA:TMPTA | 20:60:20 | | | 139 | 1608 |
| IBOMA:DPGDA:TMPTA | 20:50:30 | | | 141 | 1512 |
| IBOMA:DPGDA:TMPTA | 20:40:40 | | | 143 | 1837 |
| IBOMA:DPGDA:TMPTMA | 20:40:40 | | | 159 | 2116 |
| DPGDA:TMPTMA | 20:80 | | 1824 | 149 | 2113 |
| IBOMA:TMPTMA | 25:75 | 17 | NA | 77 | 3096 |
| IBOMA:TMPTMA | 80:20 | 43 | 5200 | 176 | 2290 |
| DPGDA:TMPTMA | 80:20 | 33 | 5330 | 149 | 2107 |
| IBOMA:DPGDA:TMPTMA | 20:60:20 | 45 | 2319 | 185 | 2494 |
| IBOMA:DPGDA:PE(EO)TA | 20:60:20 | 30 | 4166 | 151 | 1345 |

A listing of all the samples of cured, impregnated graphite that were prepared, along with the properties that were measured appears in Table 3 below. Because these samples are impregnated, the strength comes from a combination of the graphite and the resin. Impregnated samples tested contained approximately 50% monomer composition by weight.

TABLE 3
Cured, impregnated graphite samples and physical properties

| | | Flexural | |
|---|---|---|---|
| | | stress at | Flexural |
| | | break | Modulus |
| | | @90° C. | @90° C. |
| Monomer composition | Ratios | from 3 pt | from 3 pt |
| sample impregnated | (weight %) | bend (MPa) | bend (MPa) |
| Hernon 994R | 100 | 19.9 | 3065 |
| IBOMA:TMPTMA | 25:75 | 23.9 | NA |
| IBOMA:TMPTMA | 80:20 | 29.5 | 5331 |
| DPGDA:TMPTMA | 80:20 | 26.3 | 4477 |
| IBOMA:DPGDA:TMPTMA | 20:60:20 | 27.7 | 5324 |
| IBOMA:DPGDA:PE(EO)TA | 20:60:20 | 24.9 | 4166 |

As is evident from the results of Tables 2 and 3, certain monomer composition comprising mixtures IBOMA, DPGDA, TMPTA, TMPTMA, and PE (EO) TA have improved properties. The best mechanical properties observed were with about 20% TMPTMA in the compositions with the remainder being a mixture of IBOMA and the diacrylate DPGDA. This is surprising given that this is not the case for any of the individual cured components. Further, the glass transition temperature (Tg) values obtained were not what would be expected from a mere weighted average of the components' Tg values. Further still, it was evident that relatively low Tg values did not necessarily result in inferior flexural stress nor that relatively high Tg values would necessarily result in superior flexural stress but a trend exists that higher Tg's correspond to improved modulus values at 100° C.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. Such modifications are to be considered within the purview and scope of the claims appended hereto.

1. A separator plate for a fuel cell comprising a porous conductive carbon substrate and a cured, impregnated monomer composition wherein the monomer composition comprises:
a first monomer selected from the group consisting of methacrylic esters and acrylic esters wherein the first monomer is a monofunctional monomer having one reactive group or a difunctional monomer having two reactive groups, the first monomer having a vapor pressure below 0.15 mm Hg@25° C. and a viscosity under 50 CPs at 25° C., and wherein the total amount of monofunctional and difunctional monomers in the composition is in a range from about 20 to about 90% by weight; and
a second monomer from the group consisting of methacrylic esters and acrylic esters wherein the second monomer is a polyfunctional monomer having three or more reactive groups and having a vapor pressure below 0.15 mm Hg@25° C., a viscosity under 200 CPs at 25° C., and wherein the total amount of polyfunctional monomers in the composition is in a range from about 10 to about 80% by weight;
and wherein the monomer composition has been impregnated and cured according to a method comprising:
obtaining the porous substrate;
preparing an impregnation mixture comprising an amount of the monomer composition impregnating the porous substrate with the monomer composition; and
curing the impregnated monomer composition in the porous substrate.

2. The separator plate of claim 1 wherein the first monomer is a monofunctional monomer selected from the group consisting of hydroxyethyl methacrylate, isobornyl acrylate, isobornyl methacrylate, adamantyl acrylate, adamantyl methacrylate, methacrylate ester, phenyl methacrylate, cyclohexyl methacrylate, benzyl methacrylate, and dihydrodicyclopentadienyl acrylate.

3. The separator plate of claim 1 wherein the first monomer is a difunctional monomer selected from the group consisting of dipropylene glycol diacrylate, 3-Hydroxy-2,2-dimethylpropyl 3-hydroxy-2,2-dimethylpropionate diacrylate, dipropylene glycol dimethacrylate, neopentyl glycol diacrylate, and dimethylol tricyclodecane diacrylate.

4. The separator plate of claim 1 wherein the second monomer is a polyfunctional monomer selected from the group consisting of trimethylolpropane trimethacrylate, pentaerythritol (ethylene oxide)n tetraacrylate, trimethylolpropane propoxylate triacrylate, and trimethylolpropane triacrylate.

5. The separator plate of claim 1 wherein the monomer composition comprises a third monomer selected from the group consisting of methacrylic esters and acrylic esters wherein the third monomer is a monofunctional or difunctional monomer having a vapor pressure below 0.15 mm Hg@25° C. and a viscosity under 50 cP at 25° C.

6. The separator plate of claim 1 wherein the first monomer is at least one of isobornyl methacrylate and dipropylene glycol diacrylate, and the second monomer is trimethylolpropane trimethacrylate.

7. The separator plate of claim 6 comprising isobornyl methacrylate, dipropylene glycol diacrylate, and trimethylolpropane trimethacrylate in a weight ratio of about 20:40:40, 20:60:20, 0:20:80, 0:80:20, 25:0:75, or 80:0:20.

8. The separator plate of claim 1 wherein the first monomer is at least one of isobornyl methacrylate and dipropylene glycol diacrylate, and the second monomer is trimethylolpropane triacrylate.

9. The separator plate of claim 8 comprising isobornyl methacrylate, dipropylene glycol diacrylate, and trimethylolpropane triacrylate in a weight ratio of about 20:70:10, 20:60:20, 20:50:30, or 20:40:40.

10. The separator plate of claim 1 wherein the first monomer is at least one of isobornyl methacrylate and dipropylene glycol diacrylate, and the second monomer is pentaerythritol (ethylene oxide)n tetraacrylate.

11. The separator plate of claim 10 comprising isobornyl methacrylate, dipropylene glycol diacrylate, and pentaerythritol (ethylene oxide)n tetraacrylate in a weight ratio of about 20:60:20.

12. The separator plate of claim 1 wherein the viscosity of the monomer composition is less than 30 cP.

13. The separator plate of claim 1 wherein the porous conductive carbon substrate is selected from the group consisting of graphite, expanded graphite, porous carbon foam, porous carbon, and carbon.

14. The separator plate of claim 13 wherein the porous conductive carbon substrate is expanded graphite.

15. A solid polymer electrolyte fuel cell comprising the separator plate of claim 1.

16. A method of making the separator plate of claim 1 comprising:
obtaining the porous substrate;
preparing the impregnation mixture comprising the amount of the monomer composition;
impregnating the porous substrate with the monomer composition; and
curing the impregnated monomer composition in the porous substrate.

17. The method of claim 16 additionally comprising:
obtaining a free radical polymerization initiator; and
preparing the impregnation mixture comprising the amount of the monomer composition with an amount of the initiator.

18. The method of claim 17 wherein the amount of the initiator comprises an amount of a first initiator and an amount of a second initiator and the method comprises:
adding the amount of the first initiator to the amount of the monomer composition;
mixing the amount of the first initiator and the amount of the monomer composition;
adding the amount of the second initiator to the mixture of the first initiator and the monomer composition; and
mixing the amount of the second initiator and the mixture of the first initiator and the monomer composition,
thereby preparing the impregnation mixture.

19. The method of claim 18 wherein the first and second initiators activate at different temperatures.

20. The method of claim 16 comprising the additional steps of:
subjecting the porous substrate to a vacuum before the impregnating step;
subjecting the impregnated porous substrate to a vacuum after the impregnating step; and
subjecting the impregnated porous substrate to air at above ambient pressure atmosphere after the step of subjecting the impregnated porous substrate to a vacuum.

21. The method of claim 17 wherein the curing step comprises:
a first heating for about 30 minutes between 70-95° C.; and
a second heating for about 30 minutes at 160-200° C.

22. The method of claim 17 wherein the storage modulus of the cured monomer composition is greater than about 1000 MPa as determined by DMA at 100° C.

23. The separator plate of claim 1 wherein the cured, impregnated monomer composition has a glass transition temperature of 140° C. or greater.
